(19) United States
(12) Patent Application Publication
(10) Pub. No.: US 2012/0314412 A1
(43) Pub. Date: Dec. 13, 2012

(54) LED Lighting Device for Producing Multi-Chromatic Light Radiation

(75) Inventors: Simone Capeleto, Padova (IT); Francesco Martini, Padova (PD) (IT); Matteo Toscan, Maser (Treviso) (IT); Lorenzo Roberto Trevisanello, Abano Terme (PD) (IT)

(73) Assignee: OSRAM AG, Munich (DE)

(21) Appl. No.: 13/513,853

(22) PCT Filed: Dec. 1, 2010
(86) PCT No.: PCT/EP10/68660

§ 371 Date: Aug. 13, 2012

(30) Foreign Application Priority Data
Dec. 4, 2009 (IT) TO2009A000954

(51) Int. Cl. F21V 9/10

(52) U.S. Cl. 362/231

(57) ABSTRACT

A lighting device (100) including light radiation sources that can be mixed (102) to produce multi-chromatic light radiation (W; W1, W2, W3, W4; WS) as an additive mixture of the radiations generated by said sources, comprising a plurality of sets (1, 1′; 2, 2′; 3, 3′; 1, 2, 3; 1′, 2′, 3′; 1, 1′; 2, 2′; 3, 3′; 4, 4′; 1, 2, 3, 4, 5, 6) of light radiation sources, wherein each set includes light radiation sources that can be mixed (102) to produce multi-chromatic light radiation through additive mixing of the radiations generated by the sources in the set; and a control device (10, 10′, 1000) to selectively activate the sets (1, 1′; 2, 2′; 3, 3′; 1, 2, 3; 1′, 2′, 3′; 1, 1′; 2, 2′; 3, 3′; 4, 4′; 1, 2, 3, 4, 5, 6) of radiation sources in said plurality

### RELATED APPLICATIONS

This is a U.S. National Phase Application under 35 USC 371 of International Application PCT/EP2010/068600 filed on Dec. 1, 2010.

This application claims the priority of Italian application no. TO2009A000954 filed Dec. 4, 2009, the entire content of which is hereby incorporated by reference.

### FIELD OF THE INVENTION

The present description relates to lighting devices and, more particularly, to lighting devices capable of generating multi-chromatic light radiation (for example ‘white’ light) and comprising several sources (for example, a set of LEDs) of component radiations to be mixed to produce the multi-chromatic light radiation through additive mixing of said component radiations.

### BACKGROUND OF THE INVENTION

In general lighting applications, the lighting devices are normally described by means of the parameter known as ‘Color-Correlated Temperature’ (henceforth written as CCT). This parameter provides an indication of the ‘color’ of the emitted light radiation. The capacity to render the proper colors of an illuminated scene is, on the other hand, described by means of the parameter denoted as Color Rendering Index (henceforth written as CRI) This index depends on the emission spectrum of the device.

Illuminating devices with a high CRI are normally preferred for their capacity to render the colors in a ‘balanced’ or ‘equalized’ fashion. However, for specific applications, in order to obtain the enhancement of given wavelength bands, in other words certain chromatic components such as for example the color of some products, devices with a low CRI may be used. In the latter case, these are not low quality devices, but devices that are deliberately aimed at giving rise to an Unbalanced’ appearance of colors: for example, the predominance of the red band in the radiation used to illuminate a red apple renders the illuminated apple ^{x}even more red’, whereas the predominance of the green band in the radiation used to illuminate a green apple renders the illuminated apple ^{x}even more green’.

There currently exist lighting devices capable of generating light radiation as an additive mixture of several component radiations produced by a plurality of radiation sources (for example, a set of LEDs emitting at various wavelengths). In these devices, it is possible to vary the color of the emitted radiation and to generate either ^{x}white’ light or colored light with variable chromatic characteristics over a broad spectrum. In order to achieve this result, a set of sources of light radiation is used, for example colored LEDs, with complementary chromatic characteristics, for example three LEDs that respectively emit in the Red band, in the Green band and in the Blue band so as to form a tri-chromatic RGB system, to which is sometimes added another white LED device. The variation of the color of the emitted radiation is obtained by selectively varying the intensity of the component radiations emitted from the various sources.

For the lighting devices of more general use, preference is usually given to lighting devices that emit white radiation with a high value of CRI, hence radiation in which no chromatic component is prevalent, and in which it is more important that the final emission spectrum be uniform so as to obtain a value of CRI that is as high as possible. This also applies in the case of lighting devices for which it is desired to choose the color temperature of the resulting white radiation (so as to have either a “warmer” or a “colder” white light). Also in this case, the assignment of the emission bands of the various LEDs of the lamp, together with the relative combinations of spectra, are defined with the aim of maximizing the CRI, hence being moved in exactly the opposite direction with respect to the direction in which they are moved when it is desired to achieve an effect of enhancement of a particular chromatic component.

In contrast, the lighting devices that are designed for this other purpose (in other words the enhancement of a particular chromatic component: for example, predominance of the red band for lighting red apples) are noteworthy as lighting devices with chromatic characteristics that are practically fixed. As a consequence of this, a lighting device created in order to enhance, for example, the red band is generally unusable, for example, for illuminating with a chromatic enhancement effect a green colored object: on the contrary, the final effect can turn out to be that the green object illuminated with red light, rather than enhancing its appearance, is seen to assume a completely wan appearance.

From what has previously been said arises the need to dispose of lighting devices capable of combining the positive aspects of the solutions described hereinabove that overcome the inherent drawbacks therein, with, for example, the possibility of varying the emission spectrum according to the chromatic band that it is desired to enhance working in situ, in other words using—if necessary also during operation—the control of the various radiation sources present in the device, without modifications to the lighting device.

At the same time, the CCT is held constant, or an additional feature is provided for adjusting the white, while maximizing the output intensity or applying any other control strategy.

### SUMMARY OF THE INVENTION

One object of the present invention is to satisfy the aforementioned requirements.

This and other objects are attained in accordance with one aspect of the present invention directed to a lighting device including light radiation sources that can be mixed to produce multi-chromatic light radiation as an additive mixture of the radiations generated by said sources, comprising a plurality of sets of light radiation sources, wherein each set includes light radiation sources that can be mixed to produce multi-chromatic light radiation through additive mixing of the radiations generated by the sources in the set, and a control device to selectively activate the sets of radiation sources in said plurality.

Various embodiments provide a multichannel lighting device, in other words comprising a plurality of lighting radiation sources, in which several combinations of bands can deliver by additive mixing the same resultant white light (in other words the same CCT), with the possibility to select in situ one of such combinations according to the lighting requirements. This means that:

whatever the combinations of bands (in other words the combinations of radiation sources) used, it is possible to obtain a totally white illumination (CCT), and
the individual combination of bands each time preselected is capable of providing the desired enhancement effect for the desired lighting effect.

For example:
a given combination of bands (in other words of radiation sources, for example LEDs) can provide a CCT of 3000 K, accentuating the red band in order to illuminate with an enhancement effect, for example, red apples, and
   a different combination of bands can provide the same CCT of 3000 K, but accentuating the green band in order to illuminate with an enhancement effect, for example, green apples.

### BRIEF DESCRIPTION OF THE DRAWINGS

FIG. 1 illustrates the principle of operation of a first embodiment,

FIG. 2 is a schematic circuit diagram of the structure of one embodiment,

FIG. 3 illustrates the principle of operation of one embodiment,

FIG. 4 illustrates the structure of one embodiment, FIG. 5 illustrates the principle of operation of a one embodiment,

FIG. 6 illustrates the principle of operation of one embodiment, and

FIG. 7 illustrates the structure of one embodiment.

### DETAILED DESCRIPTION OF THE DRAWINGS

In the following description, various specific details are illustrated for the purpose of a better understanding of the embodiments. The embodiments may be implemented without one or more of the specific details, or with other methods, components, materials, etc. In other cases, known structures, materials or modes of operation are not shown or described in detail in order to avoid obscuring various aspects of the embodiments.

The reference to “an embodiment” within the scope of this description is used to indicate that a particular configuration, structure or feature described in relation to the embodiment is comprised within at least one embodiment. Thus, phrases such as “in one embodiment”, which may occur at various places in this description, do not necessarily refer to the same embodiment. Furthermore, particular layouts, structures or features may be combined in an appropriate manner in one or more embodiments.

The references used here are only for convenience and do not therefore define the range of protection or the scope of the embodiment.

One of the basic principles of colorimetry states that any color may be generated as a mixture of component radiations defining a tri-chromatic system: each point inside a so-called “triangle of colors” represents a color that is obtainable by mixing in appropriate amounts three colors referred to as primary colors, chosen in such a manner that none of them can be obtained with any mixture of the other two. This is the rule for additive mixing, foundation of the tri-chromatic theory.

In the case of the RGB system, used, for example, for the reproduction of the color images on television and computer screens, on photographic and video cameras, and also for the capture of color images, the component radiations defining the tri-chromatic system are red, green and blue component radiations, whence the denotation RGB (Red-Green-Blue) assigned to such a chromatic system.

More generally, as is well known to those skilled in the art of colorimetry, within the area of a color triangle, each point represents light radiation with given chromatic characteristics, whereas the mixing of two colors is represented by points from the segment connecting the two points representing the colors that are mixed. Thus, the segment that connects two points comprises all the colors able to be reproduced by mixing the appropriate quantities of the two colors of the radiation represented by the end points. The quantities of the two colors to be mixed in order to obtain a given color are inversely proportional, when the units of the primary colors are fixed, to the lengths of the segments that connect the point corresponding to the mixture with the two ends of the segment.

Within the area of a color triangle, a geometry equivalent to a normal geometry can thus be applied, by which, as can be seen, an intermediate point on the segment of line linking two points corresponds to radiation exhibiting chromatic characteristics that are intermediate with respect to the characteristics of the radiation corresponding to the two ends of the segment. In an analog manner, the baricenter of the triangle defined by three points corresponds to radiation exhibiting ^{x}baricentric’ chromatic characteristics with respect to the chromatic characteristics of the three points that represent the vertices.

Accordingly, it follows that it is possible to define a practically infinite number of sets (pairs, triads, quads, etc.)—different from one another—of chromatic components able to give rise, by mixing together, to the same resultant radiation (for example ^{x}white’ radiation, or white light).

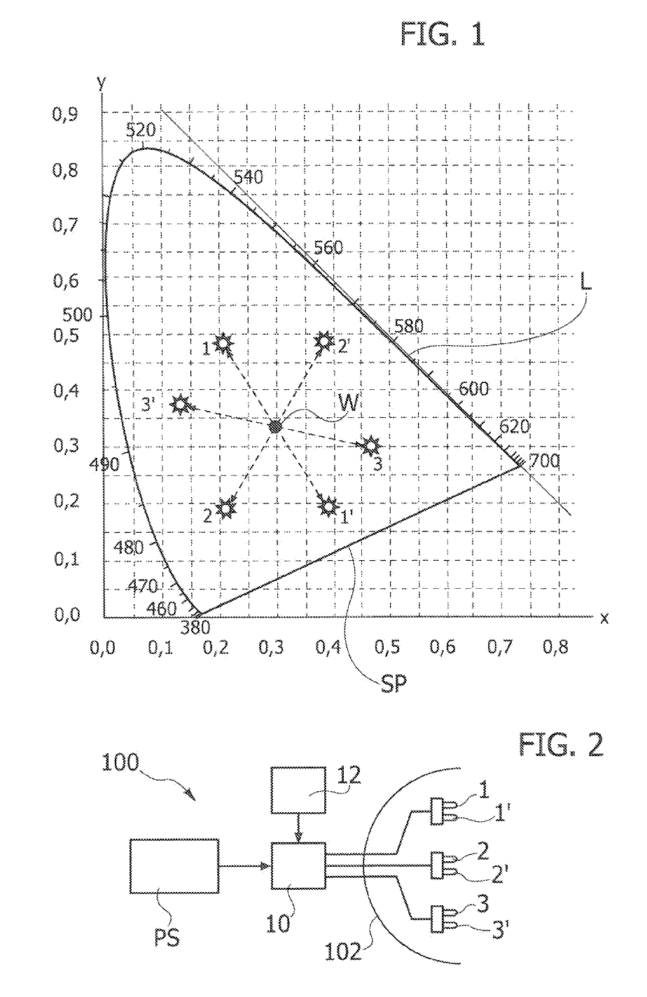

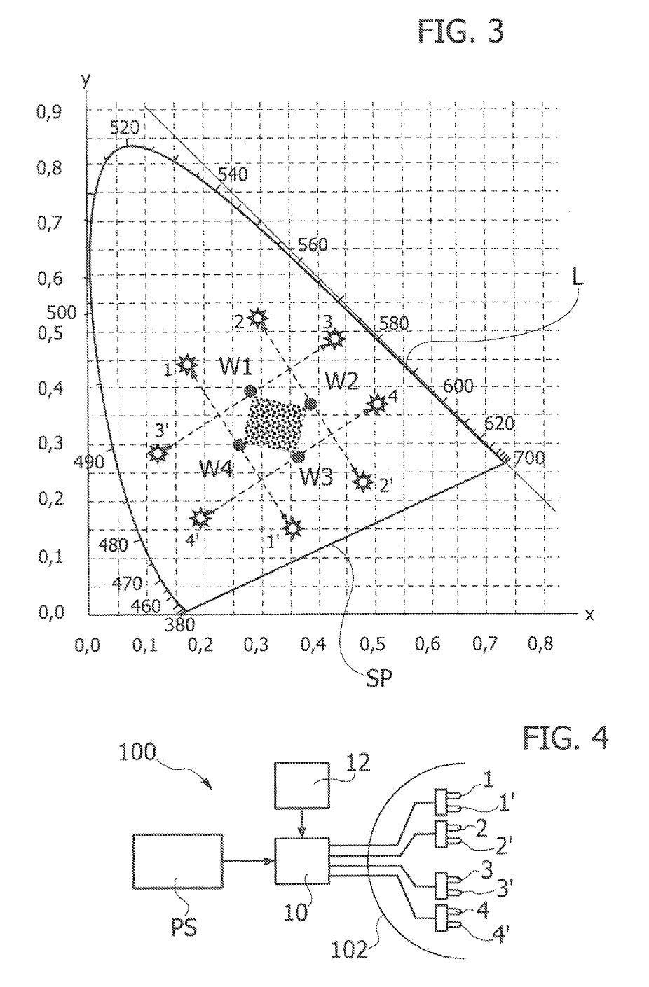

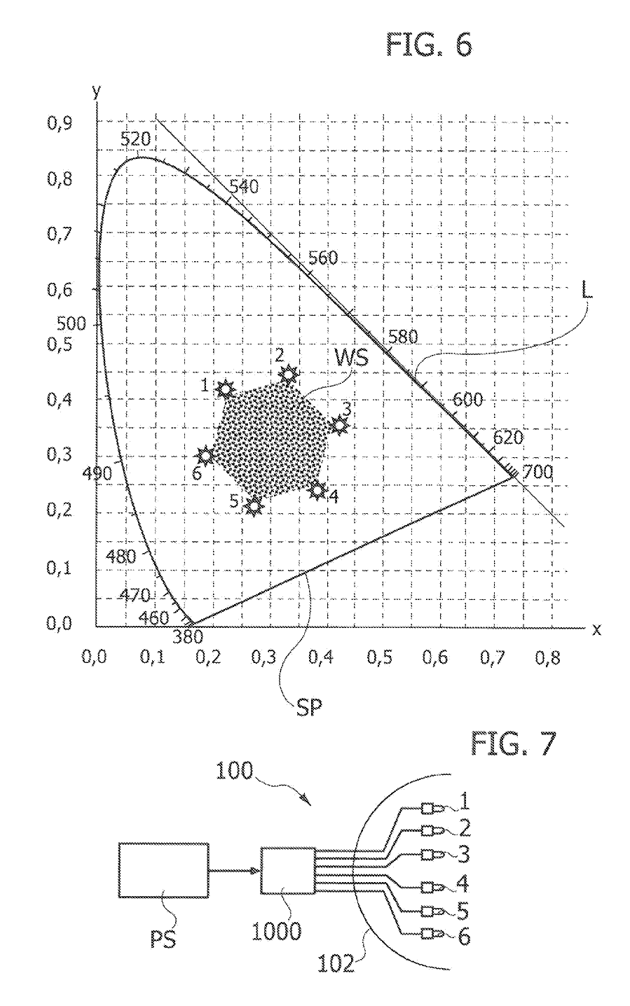

The drawing in FIG. 1 (and the same goes for the drawing in FIG. 3 and the drawing in FIG. 6) refers to the so-called Cartesian color space (colorimetric diagram) in the CLE. 1931 system.

In such a diagram, the reference L indicates the spectral line position of the color points that represent the monochromatic colors of the spectrum, whereas the line SP is the line known as the line of the saturated purples, in other words the location of the points representative of the colors obtainable by mixing of the colors corresponding to the ends of the spectral line L.

Various embodiments are based on the criterion of generating multi-chromatic light radiation (such as for example ^{x}white’ radiation) by an additive mixing of a set of component radiations. In particular, various embodiments are designed to provide a plurality of sets (pairs, triads, etc.)—different from one another—of component radiations that are to be mixed together with the possibility of activating said sets of component radiations in a selective manner, in other words, for example, activating one system of light radiation sources (e.g. LEDs) in place of another.

As an example, in the drawing in FIG. 1, the point W can be the point representing the white of equal intensity, which can be generated by alternately (completely) mixing together three different pairs of component radiations, in other words:

radiation corresponding to the point 1 and radiation corresponding to the point 1′;
radiation corresponding to the point 2 and radiation corresponding to the point 2′;
radiation corresponding to the point 3 and radiation corresponding to the point 3′.

In fact, in all three cases, the point W is ^{x}baricentric’ (central) with respect to the points corresponding to the mixed component radiations.

The choice of one or other pair of component radiations (1 and 1′; 2 and 2′; or 3 and 3′) leaves unaltered the resultant multi-chromatic light radiation (in other words the radiation corresponding to the point W), but produces enhancement effects for different chromatic components: the sources activated in order to generate the mixed component radiations are actually different, with different chromatic (hence enhancement) characteristics. Even if the appended figures do not allow for color reproduction, the fact that, for example, the radiation/sources corresponding to the points 2, 1′ and 3 (quite close to the line of the saturated purples SP) correspond to colors that are completely different from one another is immediately evident.

It will furthermore be appreciated that the same criterion previously described with reference to pairs of radiation/sources may be applied (perhaps in a more intuitive manner in view of the habit of reasoning in terms of trichromatic systems), for example, to triads of radiation/sources.

Accordingly, still referring to the drawing in FIG. 1, it can be noted that the point W representing the white of equal intensity is also able to be reproduced by alternately (completely) mixing together two different radiation triads:

the first triad, identified by the points identified with 1, 2 and 3, and
the second triad, identified by the points identified with 1′, 2′ and 3′.

As in the preceding case, the result of the above is to leave unaltered the resultant multi-chromatic light radiation corresponding to the ^{x}baricentric’ point W, but produces enhancement effects for different chromatic components depending on the specific sources (1, 2, 3 or 1′, 2′, 3′). Although the description hereinabove has been presented assuming for simplicity that the radiation W can be generated using, alternately, one of the radiation pairs 1 and 1′ or 2 and 2′ or 3 and 3′, (completely) alternately from one another, or one of the radiation triads, i.e. the triad 1, 2 and 3 or the triad 1′, 2′ and 3′, still alternately from one another, nothing prevents (thanks to the ^{x}baricentric’ position of the point W) several pairs or both the radiation/source triads in question from being activated simultaneously, if necessary with different intensity levels. This has the result of leaving unaltered the resultant multi-chromatic light radiation corresponding to the ^{x}baricentric’ point W, but leading with even more flexibility to enhancement effects for different chromatic components.

The possible generalization to sets of radiation/sources comprising a number of radiation/sources greater than two (pair) or three (triad) is immediate if it is noted that each point on the diagram in FIG. 1 corresponds to radiation that is in turn obtainable by mixing (at least) two different radiations.

FIG. 2 makes reference to a possible implementation of a lighting device 100 corresponding to the examples considered hereinabove, in other words a lighting device 1 comprising exactly six radiation sources, for example six LEDs, respectively indicated with 1, 2, 3 and with 1′, 2′ and 3′ capable of emitting, when activated, “colored” radiation corresponding to the homologous points represented on the color triangle in FIG. 1.

The schematic layout in FIG. 2 shows that within the same device or ^{x}lamp’ 100, or inside the same reflector (or analogous structure capable of performing the mixing of the radiation emitted from the various sources) 102, it is possible to install radiation sources such as LEDs 1, 2, 3, 1′, 2′, 3′ with chromatic emission characteristics corresponding to the relative points in the diagram in FIG. 1.

This is substantially analogous to a structure now consolidated by LED lamps comprising several “colored” radiation sources which may potentially be used to vary the color temperature (CCT) of the white radiation emitted.

In various embodiments, the possibility is furthermore provided of selectively connecting to a power supply device PS (of a conventional type), operating by means of a switch 10:
the first pair of LEDs 1 and 1′;
the second pair of LEDs 2 and 2′; or
the third pair of LEDs 3 and 3′.

In various embodiments, the switch 10 is, on the other hand, configured for selectively connecting to the power supply device PS:
the first triad of LEDs 1, 2, 3; or
the second triad of LEDs 1′, 2′, 3′.

Once again, it will be remembered that the device 10 may also be configured in such a manner as to simultaneously activate, if necessary with different intensity levels, several pairs or both the triads of radiation/sources in question.

In each case, since chromatic components with the same baricenter W correspond to the three pairs of LEDs or to the two triads of LEDs, the resulting white light, in other words the white light emitted from the device 100, will correspond to the same CC. The processes for achieving this result correspond to the combination of completely different chromatic components.

The solution referred to in FIGS. 1 and 2 thus allows the same resultant white radiation to be obtained within the same lamp 100, but with completely different chromatic enhancement effects depending on which and on how the three pairs of LEDs (1, 1′ or 2, 2′ or 3, 3′) or the two triads of LEDs (1, 2, 3 or 1′, 2′, 3′) is/are activated at that time by means of the switch 10.

The drawing in FIG. 2, deliberately schematic, generally identifies with 12 a function (denoted per se) designed to take into account the variation (derating) of the characteristics of the various radiation sources (LEDs) as a function of the current, of the temperature and of the aging and to compensate for the drift phenomena of the emission characteristics of the various LEDs. This is carried out so as to preserve over time the performance of the lamp 100, in particular as regards the stability of the white radiation corresponding to the baricenter W in FIG. 1.

The diagram in FIG. 3 develops the concept of Redundancy’ of the light radiation sources already introduced in FIGS. 1 and 2 proposing an embodiment in which the effect of variation of the band in which the chromatic enhancement is applied is accompanied by a variation (^{x}tuning’) of the resultant ^{x}white’ radiation.

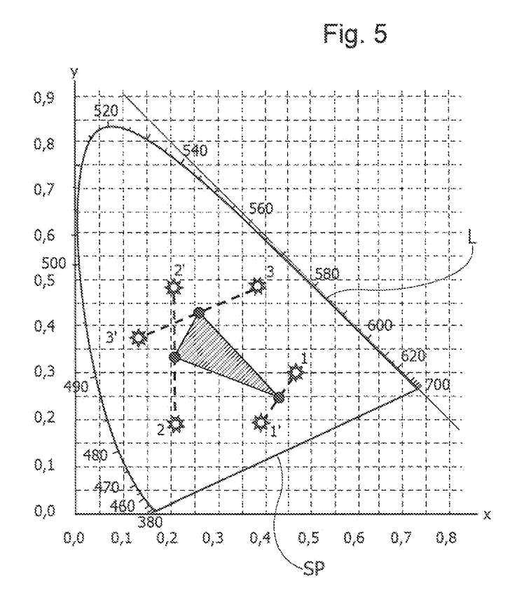

The example in FIG. 3 refers to an embodiment that may be implemented according to the general circuit diagram shown in FIG. 4, in which four pairs of radiation sources (for example LEDs) 1, 1′; 2, 2′; 3, 3′ and 4, 4′ are present in the device or lamp 100, which may be selectively activated by means of a switch 10′.

Also in this case, for simplicity, each source is identified by the point that represents the radiation emitted from it in the colorimetric diagram C.I.E. 1931 in FIG. 3. Each pair of LEDs is composed of two dual sources that identify, in a ^{x}baricentric’ position between them, a multi-chromatic light, substantially white (W1 for the LEDs 1, 1′; W2 for the LEDs 2, 2′; W3 for the LEDs 3, 3′ and W4 for the LEDs 4, 4′).

The switch 10′ in the circuit diagram in FIG. 4 allows the following to be selectively connected to the power supply device PS:
the radiation sources (LEDs) 1 and 1′
the LEDs 2 and 2′
the LEDs 3 and 3′, and
the LEDs 4 and 4′.

In this manner, aside from obtaining various combinations of emission bands (with a corresponding variation of the desired chromatic enhancement effect), it is also possible to modify the baricenter, hence the characteristics of the resultant ^{x}white’ radiation, by making the latter correspond, for example, to various different baricenters respectively indicated by W1, W2, W3 and W4.

In this case, it is also possible to enable the switch 10′ to connect simultaneously two or more pairs of sources (for example the pair of LEDs 1 and 1′ and the pair of LEDs 2 and 2′, if necessary with different intensity levels) to the power supply device PS. In addition, there is the possibility of varying the chromatic characteristics of the radiation emitted from the device 100 over the whole shaded area identified in FIG. 3 by the points W1, W2, W3 and W4.

It will be appreciated that, in this case also, what was said previously with reference to the—pairs—of sources 1, 1′; 2, 2′; 3, 3′ and 4, 4′ may be applied to triads, quads or, in general, sets of more sources.

The same principle as in FIG. 4 may be applied to a device built according to FIG. 2 if the LEDs forming pairs are chosen in a different way than in FIG. 1, as it is sketched in FIG. 5: Chosing LEDs of different colors, also resulting in the effect of variation of the band in which the chromatic enhancement is applied is accompanied by a variation (^{x}tuning’) of the resultant ^{x}white’ radiation. The only difference to the device according to FIG. 2 therefore is the types of LEDs being combined according to FIG. 5,

Three pairs of radiation sources (for example LEDs) 1, 1′; 2, 2′; and 3, 3′ are present in the device or lamp 100, which may be selectively activated by means of a switch 10 (cf. FIG. 2).

Also in this case, for simplicity, each source is identified by the point that represents the radiation emitted from it in the colorimetric diagram C.I.E. 1931 in FIG. 5. Each pair of LEDs is composed of two dual sources that identify, in a ^{x}baricentric’ position between them, a multi-chromatic light, substantially white for at least one of the pairs (W1 for the LEDs 1, 1′; W2 for the LEDs 2, 2′; and W3 for the LEDs 3, 3′). In a special embodiment at least one of the pairs has a baricentric position that is colored, i.e. non-white.

The switch 10 in the circuit diagram in FIG. 3 allows the following to be selectively connected to the power supply device PS:
the radiation sources (LEDs) 1 and 1′
the LEDs 2 and 2′ and
the LEDs 3 and 3′.

In this manner, aside from obtaining various combinations of emission bands (with a corresponding variation of the desired chromatic enhancement effect), it is also possible to modify the baricenter, hence the characteristics of the resultant ^{x}white’ radiation, by making the latter correspond, for example, to various different baricenters respectively indicated by W1, W2, and W3.

In this case, it is also possible to enable the switch 10 to connect simultaneously two or more pairs of sources (for example the pair of LEDs 2 and 2′ and the pair of LEDs 3 and 3′, if necessary with different intensity levels) to the power supply device PS. In addition, there is the possibility of varying the chromatic characteristics of the radiation emitted from the device 100 over the whole shaded area identified in FIG. 3 by the points W1, W2, and W3.

The circuit diagram in FIG. 7 refers to an embodiment in which radiation sources, for example six LEDs, 1, 2, 3, 4, 5, 6, are provided mounted inside the reflector 102 and powered from the device PS via a regulation device 1000—such as for example a microcontroller—which is capable of selectively varying the contribution (in practice radiation intensity) emitted from each source 1, 2, 3, 4, 5, 6. Also in this case, within the sources 1, 2, 3, 4, 5, 6 a redundancy may be provided in the sense that several sets of sources of light radiation will generally be present, with each set (for example, the pair 1 and 4, 2 and 5 or 3 and 6) comprising sources of light radiation that are to be mixed to produce multi-chromatic light radiation by additive mixing of the radiation generated from the sources comprised in the set.

Assuming once again that, for simplicity, each source is identified by the point that represents the radiation emitted from it in the colorimetric diagram C.I.E. 1931 in FIG. 6, it is possible to vary the chromatic characteristics of the resultant radiation in a kind of ^{x}baricenter space’ WS.

In this way, by varying (for example in a continuous manner) the weight of the various chromatic components 1, 2, 3, 4, 5, 6, aside from varying over the field WS the position of the baricenter (thus the point of the white of the resultant radiation), it is possible to vary in a corresponding manner the effect of enhancement of the desired chromatic components.

The optimum combination can be controlled by the microcontroller 1000 using a dedicated algorithm.

The various embodiments include, within the framework of a lighting device 100, the presence of several different (sub) sets of radiation sources each of which is capable, by mixing, of giving rise to a substantially white radiation. The choice of the specific subset then determines a variation of the chromatic enhancement characteristics obtained. In a special embodiment also at least one of the subsets may be designed to be capable, by mixing, of giving rise to a colored, i.e. non-white radiation.

Various embodiments allow a single lamp 100 to be developed that is usable for a wide range of applications, in particular with the possibility of obtaining a chromatic enhancement effect in a selectively variable chromatic band. The customer's logistics is simplified and likewise his final installation is optimized in that the same set of lamps with the same combination of bands can be mounted in order to illuminate different scenes. In addition to which, by means of a quick calibration, it is possible to choose in situ the best combination of bands according to the perception and/or to the indications of the user and/or customer. During its useful lifetime, the lamp may be subject to variations in the combinations of bands in order to meet the requirements for different lighting chromatic characteristics (for example a change in the products or goods to be illuminated). It is also possible to develop as a further feature of the invention a capability for automatically determining the combinations of bands, where such a selection may be carried out for example by closed-loop control of the operation of the lamp L with optical sensors able to supply a feedback signal.

It goes without saying that the principle of the invention remains unchanged, although the specifics of the implementation and the embodiments may vary, even significantly, with respect to which it is illustrated purely by way of non-limiting example, without straying from the scope of the invention as defined in the appended claims. This can be valid in particular as regards the possibility of using sources of light radiation different from LEDs, for example OLEDs or substantially monochromatic light sources of another nature.

1. A lighting device including light radiation sources that can be mixed to produce multi-chromatic light radiation as an additive mixture of the radiations generated by said sources, comprising:
a plurality of sets of light radiation sources, wherein each set includes light radiation sources that can be mixed to produce multi-chromatic light radiation through additive mixing of the radiations generated by the sources in the set; and
a control device to selectively activate the sets of radiation sources in said plurality.

2. The lighting device as claimed in claim 1, wherein said control device is configured for activating selectively and alternatively the sets of sources of said plurality.

3. The lighting device as claimed in claim 1, wherein said control device is configured for simultaneously activating plural sets of radiation sources of said plurality.

4. The lighting device as claimed in claim 1, wherein said control device is configured for selectively varying the intensity of the mixable radiations emitted by said radiation sources.

5. The lighting device as claimed in claim 1, wherein said plurality of sets of radiation sources includes at least one first set of radiation sources and at least one second set of radiation sources wherein to each radiation source in said first set there corresponds a corresponding source in said second set.

6. The lighting device as claimed in claim 1, wherein each said set of radiation sources includes sources of radiations which correspond to points in the Cartesian colorimetric diagram in the C.I.E. 1931 system jointly defining a barycentric point or region.

7. The lighting device as claimed in claim 6, wherein at least one of the barycentric points or the barycentric region is corresponding to a white radiation.

8. The lighting device as claimed in claim 6, wherein all of the barycentric points or the barycentric region are corresponding to a white radiation.

9. The lighting device as claimed in claim 6, wherein said sets of radiation sources of said plurality define one and the same barycentric point.

10. The lighting device as claimed in claim 6, wherein said sets of radiation sources of said plurality define mutually dissimilar respective barycentric points.

11. A method of generating multi-chromatic light radiation as an additive mixture of component light radiations,
comprising the steps of:
providing a plurality of sets of said component radiations, each set adapted to produce a multi-chromatic light radiation as an additive mixture of the component radiations in the set; and
selectively activating the sets of component radiations in said plurality.
